(19) United States
(12) Patent Application Publication
(10) Pub. No.: US 2022/0407174 A1
(43) Pub. Date: Dec. 22, 2022

(54) FIRE SUPPRESSION SYSTEM FOR A VEHICLE

(71) Applicant: Tyco Fire Products LP, Lansdale, PA (US)

(72) Inventors: Derek M. Sandahl, Wallace, MI (US); Alden A. Spencer, Marinette, WI (US); Kristin M. Ryczek, Oconto Falls, WI (US)

(73) Assignee: Tyco Fire Products LP, Lansdale, PA (US)

(21) Appl. No.: 17/774,466

(22) PCT Filed: Dec. 4, 2020
(86) PCT No.: PCT/IB2020/061532

§ 371 Date: May 4, 2022

Related U.S. Application Data
(60) Provisional application No. 62/944,226, filed on Dec. 5, 2019.
(60) Provisional application No. 62/964,390, filed on Jan. 22, 2020.

(51) Int. Cl. H01M 50/383; A62C 3/16; A62C 37/40; H01M 50/204; H01M 10/42; H01M 50/249; H01M 10/48

(52) U.S. Cl. CPC H01M 50/383; A62C 3/16; A62C 37/40; H01M 50/204; H01M 10/425; H01M 50/249; H01M 10/482; H01M 10/486; H01M 2010/4271; H01M 2220/20; B60L 3/12

(57) ABSTRACT

A fire suppression system for a vehicle includes a housing, multiple battery cells positioned within the housing, an off-gas detector, and a controller. The off-gas detector is provided within the housing and is configured to detect a presence of off-gas in the housing. The controller is configured to receive signals from the off-gas detector indicating whether off-gas is detected in the housing, and activate a fire suppression apparatus to provide fire suppressant agent to any of an exterior or interior of the housing in response to detecting off-gas in the housing.

### CROSS-REFERENCE TO RELATED PATENT APPLICATION

This application claims the benefit of and priority to U.S. Provisional Application No. 62/964,390, filed Jan. 22, 2020, and U.S. Provisional Application No. 62/944,226, filed Dec. 5, 2019, the entire disclosures of which are incorporated by reference herein.

### BACKGROUND

Fire suppression systems are commonly used to protect an area and objects within the area from fire. Fire suppression systems can be activated manually or automatically in response to an indication that a fire is present nearby (e.g., an increase in ambient temperature beyond a predetermined threshold value, etc.). Once activated, fire suppression systems spread a fire suppressant agent throughout the area. The fire suppressant agent then suppresses or controls (e.g., prevents the growth of) the fire.

### SUMMARY

One implementation of the present disclosure is a fire suppression system for a vehicle. In some embodiments, the fire suppression system includes a housing, multiple battery cells positioned within the housing and configured to provide power to a system of the vehicle, an off-gas detector, and a controller. In some embodiments, the off-gas detector is coupled to the housing and is configured to detect a presence of off-gas in the housing. In some embodiments, the controller is configured to receive signals from the off-gas detector indicating whether off-gas is detected in the housing, and activate a fire suppression apparatus to provide fire suppressant agent to any of an exterior or interior of the housing in response to detecting off-gas in the housing.

In some embodiments, the fire suppression system includes one or more temperature sensors configured to be positioned about the vehicle and detect temperatures at multiple locations about the vehicle.

In some embodiments, the controller is configured to selectively activate the fire suppression apparatus to provide the fire suppressant agent to one or more of the multiple locations about the vehicle based on the detected temperatures.

In some embodiments, the off-gas detector includes multiple of the off-gas detectors. In some embodiments, each of the multiple off-gas detectors is configured to detect the presence of off-gas emitted by corresponding battery cells.

In some embodiments, the off-gas detector is configured to detect a presence or concentration of any of a lithium-ion battery off-gas, carbon dioxide, methane, ethane, hydrogen, oxygen, nitrogen oxides, volatile organic compounds, ash, soot, hydrogen sulfide, sulfur oxides, ammonia, chlorine, propane, ozone, ethanol, hydrocarbons, hydrogen cyanide, combustible cases, flammable gases, toxic gases, corrosive gases, oxidizing gases, or an electrolyte vapor in an air sample.

In some embodiments, the controller is configured to receive signals from the off-gas detector indicating a concentration of off-gas and compare the concentration of off-gas to a threshold value. In some embodiments, the controller is configured to activate the fire suppression apparatus in response to the concentration of off-gas in an air sample exceeding the threshold value.

In some embodiments, the controller is configured to deactivate the battery cells in response to detecting the off-gas in the housing.

In some embodiments, the battery cells are removable from the housing.

In some embodiments, the fire suppression system further includes a first fire suppression apparatus and a second fire suppression apparatus. In some embodiments, the first fire suppression apparatus is configured to provide a first type of fire suppressant agent to the housing and the second fire suppression apparatus is configured to provide a second type of fire suppressant agent to the housing.

In some embodiments, the controller is configured to activate the first fire suppression apparatus to provide the first type of fire suppressant agent to the battery cells at a first time, and activate the second fire suppression apparatus to provide the second type of fire suppressant agent to the battery cells at a second time. In some embodiments, wherein the second time occurs after the first time.

Another implementation of the present disclosure is a vehicle, according to some embodiments. In some embodiments, the fire suppression system includes a housing, battery cells positioned within the housing, an off-gas detector, and a controller. In some embodiments, the off-gas detector is provided within the housing and configured to detect a presence of off-gas in the housing. In some embodiments, the controller is configured to receive signals from the off-gas detector indicating whether off-gas is detected in the housing and activate a fire suppression apparatus to provide fire suppressant agent to the battery cells in response to detecting off-gas in the housing.

In some embodiments, the vehicle further includes an electric motor configured to draw power from the battery cells for one or more operations of the vehicle.

In some embodiments, the one or more operations of the vehicle powered by the electric motor and the battery cells include any of a driving operation, lighting operations, accessory drive operations, or vehicle-specific operations.

In some embodiments, the vehicle further include one or more temperature sensors positioned about the vehicle and configured to detect temperatures at different locations about the vehicle.

In some embodiments, the controller is configured to selectively activate the fire suppression apparatus to provide the fire suppressant agent to one or more of the different locations about the vehicle based on the detected temperatures.

In some embodiments, the off-gas detector includes multiple of the off-gas detectors. In some embodiments, each of the multiple off-gas detectors are configured to detect the presence of off-gas emitted by corresponding battery cells.

Another implementation of the present disclosure is a method for detecting a fire condition of a vehicle and responding to the fire condition, according to some embodiments. In some embodiments, the method includes sampling air in a battery rack of the vehicle. In some embodiments, the battery rack includes multiple batteries configured to power a vehicle system. In some embodiments, the method includes determining a concentration of the off-gas in the air sampled from the battery rack of the vehicle. In some embodiments, the method includes comparing the concentration of the off-gas in the air to a threshold concentration. In some embodiments, the method includes activating a fire suppression system of the vehicle in response to the concentration of the off-gas in the air exceeding the threshold concentration.

In some embodiments, the method further includes obtaining temperature data and smoke detection data from one or more sensors of the battery rack. In some embodiments, the method further includes analyzing the temperature data and the smoke detection data to determine if at least one of the temperature data or the smoke detection data indicates that a fire condition is present and activating the fire suppression system of the vehicle in response to at least one of the temperature data or the smoke detection data indicating that the fire condition is present.

In some embodiments, obtaining the temperature data and the smoke detection data, analyzing the temperature data, and activating the fire suppression system are performed in response to the concentration of the off-gas in the air being less than the threshold concentration.

In some embodiments, the method further includes, in response to the concentration of the off-gas in the air exceeding the threshold concentration, providing an alert to an operator of the vehicle, and shutting off electrical power to the battery rack.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying FIGURES, wherein like reference numerals refer to like elements, in which:

FIG. 1 is a block diagram of a fire suppression system for a vehicle usable with a battery rack of the vehicle, according to some embodiments.

FIG. 2 is a block diagram of a fire suppression system for a vehicle usable with multiple battery racks of the vehicle, according to some embodiments.

FIG. 3 is a block diagram of a controller usable with the fire suppression systems of FIGS. 1-2, according to some embodiments.

FIG. 4 is a flow diagram of a process for suppressing fires on a vehicle with one or more battery racks, according to some embodiments.

FIG. 5 is a schematic diagram of a fire suppression system, according to some embodiments.

FIG. 6 is a schematic diagram of a fire suppression system for a vehicle, according to some embodiments.

### DETAILED DESCRIPTION

Before turning to the FIGURES, which illustrate the exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

### Overview

Referring generally to the FIGURES, a fire suppression system is shown, according to some embodiments. The fire suppression system is, in some embodiments, usable with batteries and/or battery racks of a vehicle. In some embodiments, the fire suppression system is configured for use with a pre-existing vehicular fire suppression system or infrastructure of the vehicle. The batteries may be stored within a container (e.g., a housing) on the vehicle. The fire suppression system can include an off-gas detector configured to monitor and detect the presence of off-gas in the container (e.g., off-gases emitted by the batteries as the batteries begin to fail) of the vehicle. In some embodiments, one or more off-gas detectors are positioned at and associated with each battery. In other embodiments, a single off-gas detector is positioned within the internal volume of the container. The fire suppression system can include a controller that receives signals generated by the off-gas detector to indicate a concentration and/or presence of off-gas.

If the concentration or level of off-gas emitted by the battery rack(s) exceeds a threshold value (e.g., a predetermined threshold value), this may indicate that a fire is likely to occur in the near future or that thermal runaway (e.g., a rapid increase in temperature) is likely to occur in the near future. The controller can activate a fire suppression apparatus to provide a fire suppressant agent to the battery racks or to other monitored areas of the vehicle to prevent the fire from occurring (e.g., to prevent or suppress combustion). Advantageously, the fire suppression system can preemptively detect and respond to conditions at the vehicle's batteries to prevent a fire from occurring.

The fire suppression system can also include any number of temperature or optical sensors positioned about the vehicle. For example, temperature and/or optical sensors may be positioned at an engine bay, near hydraulic pumps, etc., or anywhere else on the vehicle that a fire may occur. In some embodiments, the temperature and/or optical sensors are configured to measure temperature and/or light intensity and provide the measurements to the controller. In some embodiments, the controller is configured to activate the fire suppression apparatus based on the temperature and/or light intensity measurements at the monitored areas of the vehicle. Advantageously, the fire suppression system can provide single battery cell failure detection before thermal runaway occurs. When thermal runaway occurs at a single battery cell, thermal propagation may occur thereby causing a domino effect into adjacent cells and causing an increase in temperature in the adjacent cells. Off-gas detection can occur within five seconds of off-gas being generated at the battery cell. The systems and methods described herein for off-gas detection can be used in addition to or in place of uninterrupted power supply (UPS) technologies.

### Vehicular Battery Monitoring and Fire Suppression System

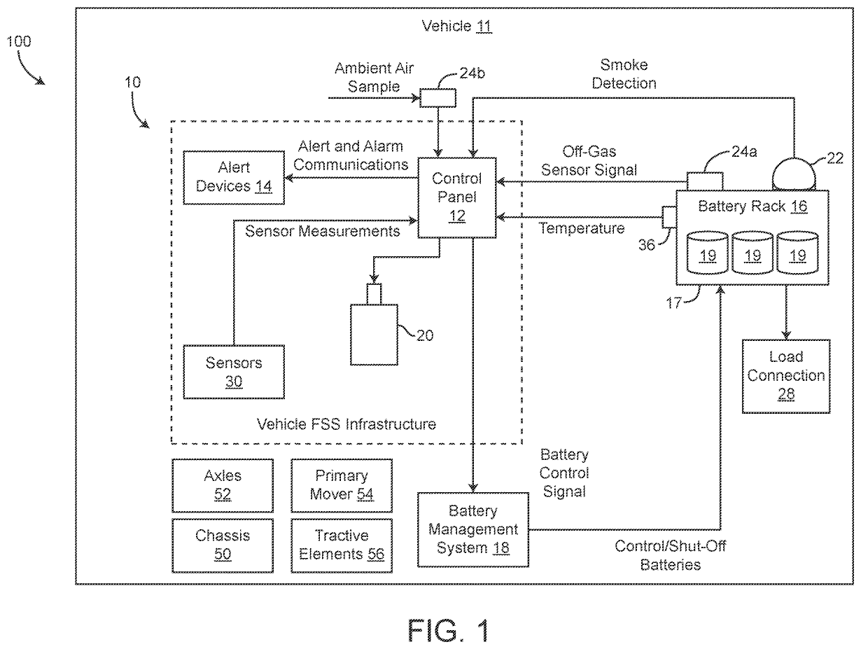

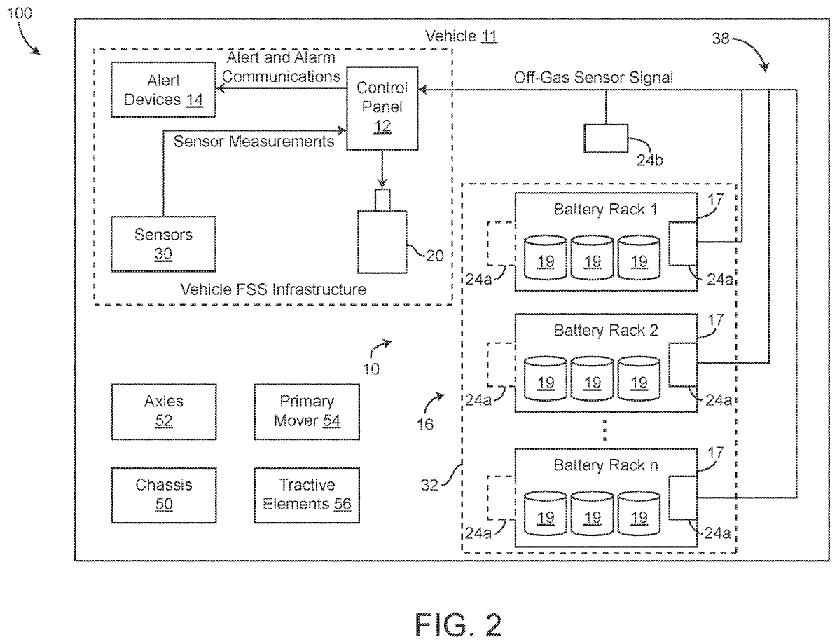

Referring to FIGS. 1-2, various embodiments of a vehicle system 100 are shown. In some embodiments, vehicle system 100 includes a vehicle 11 and a fire suppression system 10. In some embodiments, fire suppression system 10 is configured to monitor smoke and/or gases emitted by one or more batteries, lithium-ion batteries, battery racks, lithium-ion battery racks, etc., of vehicle 11. Fire suppression system 10 can monitor off-gas concentration and/or smoke detection at the batteries to determine if a fire is likely to occur in the near future or if otherwise undesirable conditions exist (e.g., elevated temperatures, etc.). In some embodiments, fire suppression system 10 is configured to activate various fire suppression apparatuses (e.g., an inert gas system, a foam system, a water and/or chemical agent system, etc.) to suppress and prevent the occurrence of fire on the vehicle 11. Advantageously, fire suppression system 10 may prevent thermal runaway at the batteries and prevent the lithium ion batteries from combusting on the vehicle.

Preventing thermal runaway of the lithium ion batteries is advantageous since after lithium-ion batteries combust, they can be difficult to extinguish. Therefore, monitoring the gas emitted by the lithium-ion batteries and activating the fire suppression system in advance of thermal runaway may prevent or suppress the start and/or growth of the fire, thereby facilitating a preventative fire suppression system.

Referring further to FIG. 1, fire suppression system 10 of vehicle system 100 includes a control panel 12 (e.g., a fire panel, a controller, a processing unit, a processing device, a computer, a microcontroller, a microprocessor, etc.) and a battery rack 16 (e.g., a battery, a set of batteries, a lithium-ion battery, an energy storage system (ESS), etc.). Vehicle 11 includes an air sampling detector 24a (e.g., an off-gas detector, a sensor, etc.) and an air sampling detector 24b, according to some embodiments. In some embodiments, air sampling detector 24a is configured to monitor or sense the presence of off-gas emitted by battery cells 19 (e.g., lithium-ion battery cells of battery rack 16). In some embodiments, air sampling detector 24b is functionally the same as air sampling detector 24a such that any of the functionality of air sampling detector 24a may be said of air sampling detector 24b. In some embodiments, air sampling detector 24b is configured to perform or facilitate off-gas detection of ambient air (e.g., at a location a distance from battery rack 16) to provide a reference or a baseline off-gas concentration for fire panel 12. In some embodiments, air sampling detector 24b is integrated in a same housing or a same unit with air sampling detector 24a. In some embodiments, the battery cells 19 of battery rack 16 are a gas source that emit the off-gas. In some embodiments, air sampling detector 24a is a gas analyzer, a gas sensor, etc., configured to detect the presence of off-gas emitted by the battery cells 19 of battery rack 16. Air sampling detector 24a can be configured to draw samples of air/gas from within battery rack 16 and may analyze the samples to detect the presence or concentration of off-gas in the sample. In some embodiments, air sampling detector 24a is configured to detect the presence or concentration of any of a lithium-ion battery off-gas, carbon dioxide, carbon monoxide, methane, ethane, hydrogen, oxygen, nitrogen oxides, volatile organic compounds, ash, soot, hydrogen sulfide, sulfur oxides, ammonia, chlorine, propane, ozone, ethanol, hydrocarbons, hydrogen cyanide, combustible gases, flammable gases, toxic gases, corrosive gases, oxidizing gases, an electrolyte vapor, etc.

In some embodiments, air sampling detector 24a is or includes an oxygen or O2 sensor. The off-gas may be detected by the O2 sensor. In some embodiments, the O2 sensor provides sensor feedback to control panel 12. Control panel 12 may track changes in oxygen concentration or oxygen levels in the battery racks 16 over time to determine if any of the battery cells 19 are emitting off-gas.

Vehicle 11 can be any residential vehicle, commercial vehicle, mobile equipment, industrial vehicle, etc. In some embodiments, vehicle 11 is a car, a truck, a hauler, a hydraulic excavator, a wheeled loader, a dozer, a grader, forestry equipment, a concrete mixer, a dump truck, transportable mining equipment, etc. In some embodiments, vehicle 11 includes a pre-existing fire suppression system or a pre-existing infrastructure for fire detection and suppression into which fire suppression system 10 is incorporated. In some embodiments, vehicle 11 is an electric vehicle that uses electrical power provided by the battery rack(s) 16 for transportation and to perform various functions (e.g., lifting, mining, drilling, etc., functions). In some embodiments, vehicle 11 is an off-road vehicle including a suspension system configured for off-road transportation. For example, vehicle 11 may be off-roading mining machinery that is transportable from location to location. In some embodiments, vehicle 11 is a locomotive, light rail, or commercial rail vehicle.

Vehicle 11 can include a chassis 50, axles 52, tractive elements 56 (e.g., wheels, treads, etc.), and a primary mover 54 (e.g., an electric motor, a diesel engine, a petroleum engine, an internal combustion engine, a steam engine, etc.) configured to drive the tractive elements 56 to transport vehicle 11. In some embodiments, the primary mover 54 is also configured to drive a generator for lighting and/or electrical applications, or to charge battery rack 16. In some embodiments, vehicle 11 includes accessories that can be driven by the primary mover 54. In some embodiments, vehicle 11 includes various hydraulic, pneumatic, etc., equipment (e.g., articulated arms, compressors, fluid systems, etc.) configured to be driven using mechanical energy output by the primary mover 54.

In some embodiments, battery rack 16 is removably electrically coupled with control panel 12 and load connection 28. In some embodiments, battery rack 16 is removably fixedly coupled with vehicle 11 (e.g., with a frame of vehicle 11, chassis 50 of vehicle 11, a structural member of vehicle 11, etc.). Similarly, fire suppression system 10 may be coupled (e.g., fixedly, removably) with chassis 50 of vehicle 11. In this way, battery racks 16 may be removed and replaced by an operator of vehicle 11. For example, battery racks 16 may be fastened to vehicle 11, interlock with a corresponding interlocking member of vehicle 11, etc.

Battery rack 16 may include multiple battery cells 19 that are configured to store electrical power (e.g., in chemical form) and discharge electrical energy for use by vehicle 11. In some embodiments, the primary mover 54 of vehicle 11 is configured to use the electrical energy discharged by battery rack 16 (e.g., if the primary mover 54 is for transportation of vehicle 11 (e.g., to drive the tractive elements 56) for driving the various accessories or equipment of vehicle 11, or for lighting applications. In some embodiments, battery rack 16 is configured to discharge electrical energy from the battery cells 19 for lighting and/or other electrical systems of vehicle 11. In some embodiments, the primary mover 54 of vehicle 11 is configured to charge the battery cells 19 of battery rack 16. Battery rack 16 can discharge energy to any of the motors, primary movers, electrical subsystems, lighting systems, etc., of vehicle 11 via a load connection 28.

In some embodiments, battery cells 19 are removably electrically coupled with control panel 12 and load connection 28 and/or removably coupled with battery rack 16. For example, battery cells 19 may be removable from battery rack 16 so that an operator can replace battery cells 19 (e.g., due to damage, low charge, etc.).

In some embodiments, air sampling detector 24a is configured to monitor and identify a presence of the off-gas emitted by the battery cells 19 of battery rack 16. In other embodiments, air sampling detector 24a is configured to measure a concentration of the off-gas emitted by battery cells 19 of battery rack 16. For example, air sampling detector 24a can measure the off-gas in parts per million. In some embodiments, air sampling detector 24a is configured to independently measure a concentration and/or a presence of each of any of the various off-gases described in greater detail above. For example, air sampling detector 24a can measure the concentration of each of lithium-ion battery off-gases, carbon dioxide, volatile organic compounds, etc., independently. In some embodiments, air sampling detector 24a is mounted (e.g., fixedly coupled, fastened, etc.) to battery rack 16. In some embodiments, air sampling detector 24a is positioned within battery rack 16 or is positioned within a housing within which battery rack 16 is positioned. In some embodiments, at least one air sampling detector 24a is positioned at each battery rack 16 and is configured to detect off-gas in battery rack 16. In some embodiments, if air sampling detector 24a is positioned at battery rack 16 (e.g., fixedly coupled with, mounted to, positioned within, etc.), air sampling detector 24a may rely on internal airflow in battery rack 16. Battery rack 16 can include a cooling fan configured to drive airflow over the battery cells 19 of battery rack 16 to force convective heat transfer (e.g., to cool the battery cells 19 in battery rack 16).

Air sampling detector 24a can provide control panel 12 with the identified presence of off-gas and/or the concentration of off-gas. In some embodiments, air sampling detector 24a provides an off-gas sensor signal to control panel 12. In some embodiments, control panel 12 uses the off-gas sensor signal to determine if a fire suppression apparatuses 20 should be activated. In some embodiments, fire suppression apparatuses 20 includes a tank, a container, a capsule, a cartridge, a pressure vessel, etc., that is configured to store and discharge a fire suppressant agent. In some embodiments, fire suppression apparatuses 20 includes any piping, plumbing, conduits, tubular members, discharge devices, nozzles, sprayers, outlets, etc., configured to fluidly couple with the tank and deliver or provide the fire suppressant agent to battery rack 16 and/or to an enclosure within which battery rack 16 is positioned, or to other areas of interest of vehicle 11. In some embodiments, fire suppression apparatuses 20 includes a cartridge, a discharge pressure vessel, a container, a capsule, etc., configured to fluidly couple with the tank that stores the fire suppressant agent. In some embodiments, the cartridge contains a pressurized discharge gas that is configured to pressurize the fire suppressant agent and drive the fire suppressant agent into or toward battery rack 16. In some embodiments, the fire suppressant agent is an inert gas, an ideal gas, etc., configured to flood and substantially fill battery rack 16. In some embodiments, the fire suppressant agent is a foam fire suppressant agent that can be sprayed onto the battery cells 19 of battery rack 16. In some embodiments, an inner volume of battery rack 16 is flooded with the fire suppressant agent. In some embodiments, an entire volume of an enclosure (e.g., a battery enclosure) within which battery rack 16 is positioned is flooded with the fire suppressant agent. In some embodiments, a liquid or dry chemical is sprayed into the battery enclosure. In some embodiments, the liquid or dry chemical is sprayed onto battery cells 19 or onto battery rack(s) 16.

Control panel 12 can receive the off-gas sensor signals from air sampling detector 24a and provide fire suppression activation signals to an activator of fire suppression apparatuses 20. In some embodiments, control panel 12 activates fire suppression apparatuses 20 by puncturing a rupture disk or otherwise fluidly coupling the cartridge that contains the discharge gas with an internal volume of the vessel that contains the fire suppressant agent. In some embodiments, control panel 12 includes a processing circuit, a processor, and/or memory configured to execute one or more processes as described herein. For example, control panel 12 can receive the off-gas sensor signals from air sampling detector 24a, compare the concentration of the off-gasses in battery rack 16 to corresponding threshold values, and perform one or more operations in response to one or more of the concentrations of the off-gases exceeding the corresponding threshold values.

Referring still to FIG. 1, vehicle system 100 can include a battery management system 18. In some embodiments, battery management system 18 is configured to operate the battery cells 19 of battery rack 16. For example, battery management system 18 can be configured to activate or de-activate the battery cells 19 of battery rack 16 so that a user, the various electrical systems, the various lighting systems, the primary mover 54, various electrical motors, etc., can draw power from the battery cells 19 of battery rack 16 (e.g., at load connection 28). In some embodiments, battery management system 18 is configured to shut down power from battery cells 19 of battery rack 16 in response to receiving control signals from control panel 12. For example, battery management system 18 can receive a command from control panel 12 to shut down battery rack 16 in response to the off-gas in battery rack 16 exceeding the corresponding threshold value. Control panel 12 can generate battery control signals based on the off-gas sensor signals and provide the battery control signals to battery management system 18. In some embodiments, battery management system 18 receives the battery control signals from control panel 12 and controls or shuts off battery rack 16 using the battery control signals. The battery control signals generated by control panel 12 and the operations performed by battery management system 18 can include changing the position of a switch, adjusting output voltage, adjusting output current, etc., of battery rack 16.

In some embodiments, vehicle system 100 or fire suppression system 10 also includes a smoke detector 22. In some embodiments, smoke detector 22 is a sensor configured to measure soot, ash, particulate matter, smoke, airborne particulate, etc. Smoke detector 22 can draw a sample of air from battery rack 16 and detect the presence or concentration of particulate (e.g., airborne particles) matter in the sample of air. In some embodiments, smoke detector 22 provides control panel 12 with smoke detection signals. In some embodiments, control panel 12 can use the smoke detection signals to activate fire suppression apparatuses 20. In some embodiments, control panel 12 uses the smoke detection to generate the battery control signals and provides the battery control signals to battery management system 18. Smoke detector 22 may be positioned at or near battery rack 16, within an enclosure that battery rack 16 is contained within, etc.

Referring still to FIG. 1, control panel 12 can provide alert and/or alarm communications/signals to one or more alert devices 14 of vehicle 11. In some embodiments, the alert/alarm signals are generated by control panel 12 based on one or more of the off-gas sensor signals (e.g., based on the presence of off-gas in battery rack 16, based on the concentration of off-gas in battery rack 16, etc.) received from air sampling detector 24a, the smoke detection signals (e.g., based on the presence of airborne particulate matter, based on the concentration of airborne particulate matter, etc.) received from smoke detector 22, etc. In some embodiments, vehicle system 100 also includes one or more temperature sensors 36 that are configured to sense a temperature within or at battery rack 16. In some embodiments, temperature sensor 36 is configured to measure or sense a temperature in a container, a housing, etc., that battery rack 16 is positioned within. In some embodiments, temperature sensor 36 is any of an optical temperature sensor, a thermocouple, a thermally responsive member, a negative temperature coefficient thermistor, a resistance temperature detector, a semi-conductor based temperature sensor, etc. In some embodiments, temperature sensor 36 provides the measured/sensed temperature of battery rack 16, temperature within battery rack 16, temperature at any or all of the battery cells 19 of battery rack 16, temperature within a container that battery rack 16 is stored within, etc., and provides the temperature to control panel 12. Control panel 12 can use the measured temperature to generate the alert/alarm signals, the battery control signals, and/or the fire suppression release signals.

Control panel 12 can also operate alert devices 14 of the vehicle 11 in response to detecting that a fire has occurred at battery rack 16, or in response to determining that a fire is likely to occur in the near-future at battery rack 16. For example, control panel 12 may use any of the off-gas sensor signals, the smoke detection signals, and/or the temperature at battery rack 16 to preemptively detect fire at battery rack 16 (e.g., to detect that a fire may occur in the near-future, before the fire occurs) and respond preemptively to prevent the fire. In some embodiments, control panel 12 preemptively detects a fire at battery rack 16 and responds to prevent thermal runaway at battery rack 16, thereby preventing a fire from occurring at battery rack 16.

In some embodiments, alert devices 14 are various light emitting devices, speakers, display screens, user interfaces, etc., of vehicle 11. For example, one or more of the alert devices 14 may be pre-existing on vehicle 11 (e.g., such as a user interface within a cab of the vehicle 11). In some embodiments, one or more of alert devices 14 are pre-existing of part of a fire suppression system of vehicle 11. For example, vehicle 11 may include a fire suppression system that is configured to monitor various areas of interest (e.g., an engine bay) of the vehicle 11 and provide fire suppression for the monitored areas of vehicle 11. In some embodiments, the air sampling detector 24a may be integrated for use with the pre-existing fire suppression system of vehicle 11. For example, the pre-existing fire suppression system of vehicle 11 may be an Automatic Fire Suppression System (AFSS) or a Checkfire 210 Detection and Actuation System, from ANSUL®, a brand of Tyco Fire Protection Products.

Referring still to FIG. 1, alert devices 14 can be or include any of a visual alert device (e.g., a light emitting device, a light emitting diode, etc.), an aural alert device (e.g., a speaker, a sound-producing device, etc.), or any combination thereof. In some embodiments, control panel 12 is configured to provide alert signals to alert devices 14 in response to detecting a fire or in response to determining that a fire is likely to occur in the near future at any of battery racks 16 (e.g., in response to detecting the presence of off-gas in any of battery racks 16, in response to detecting that the concentration of off-gas in any of battery racks 16 exceeds a corresponding threshold value, etc.), or in response to detecting that a fire has occurred at any of the areas or spaces of vehicle 11 that are monitored by sensors 30. In some embodiments, control panel 12 operates alert devices 14 to provide a visual and/or aural alert or indication to a user, driver or vehicle operator that a fire has occurred or is likely to occur. Alert devices 14 can be configured to produce a siren noise, emit a colored light, etc., in response to receiving the alert signals from control panel 12 to alert the user that a fire has occurred or is likely to occur at battery rack 16. In some embodiments, control panel 12 is configured to operate alert devices 14 in response to determining that fire suppression apparatuses 20 should be activated. In this way, alert devices 14 can be used to notify the user that fire suppression apparatuses 20 has been activated.

In some embodiments, vehicle 11 is a heavy duty industrial vehicle. If vehicle 11 is a heavy duty industrial vehicle, fire suppression system 10 may experience impacts or shocks (e.g., as vehicle 11 travels over bumps, uneven terrain, holes, etc.). For example, impacts or shocks may be transferred through the tractive elements 56 and the chassis 50 to the fire suppression system 10. In some embodiments, air sampling detector 24a is positioned entirely within battery rack 16 to facilitate robustness of fire suppression system 10. For example, air sampling detector 24a may be positioned within a sealed or vented inner volume of battery rack 16 (shown in FIG. 2), defined by housing 17 of battery rack 16. In this way, air sampling detector 24a can obtain air samples for off-gas monitoring, measurement, or detection, without requiring additional plumbing components that fluidly couple with battery rack 16. Air sampling detector 24a can be mounted within housing 17 of battery rack 16 or within another housing that contains housing 17 and battery rack 16. For example, air sampling detector 24a can be fixedly coupled with an interior surface of housing 17 of battery rack 16. In some embodiments, positioning and fixedly coupling air sampling detector 24a within housing 17 of battery rack 16 facilitates a more robust fire suppression system 10 that is resilient to shocks, impacts, or jolts that may be transferred to fire suppression system 10 through the vehicle 11. In some embodiments, positioning and fixedly coupling air sampling detector 24a within housing 17 of battery rack 16 (or within another housing that contains housing 17 of battery rack 16) removes a requirement for plumbing components (e.g., pipes, tubular members, elbows, etc.), which may be sensitive to impacts experienced by vehicle 11.

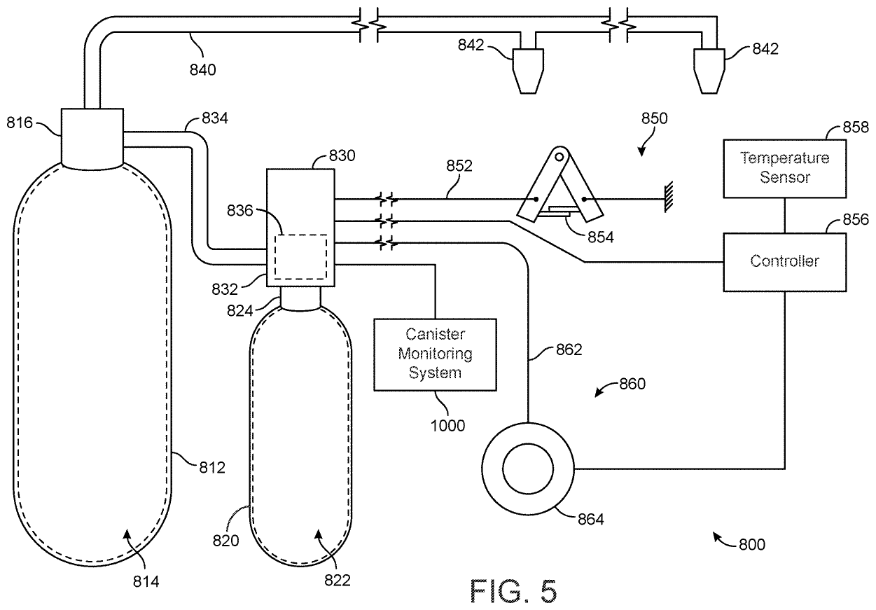

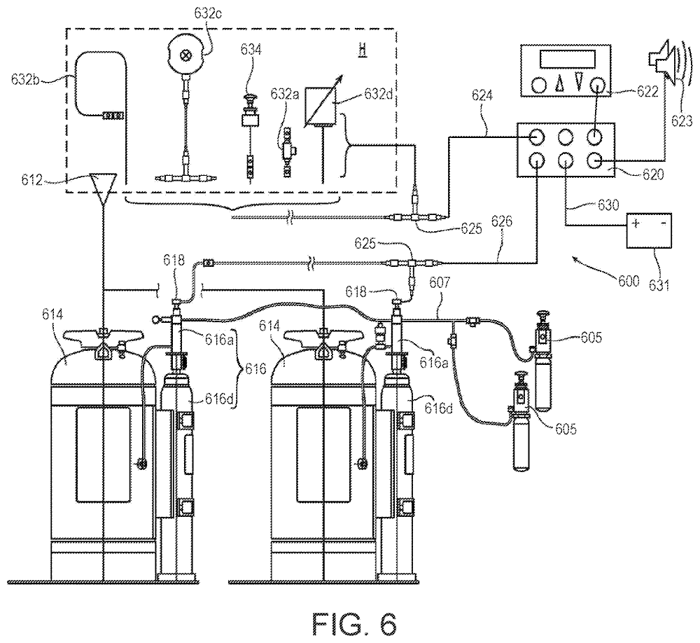

Referring still to FIG. 1, fire suppression system 10 can include fire suppression apparatuses 20, sensors 30, alert device 14, and control panel 12. In some embodiments, fire suppression apparatuses 20, sensors 30, alert device 14, and control panel 12 are components of a vehicle fire suppression system (FSS) infrastructure. For example, control panel 12 may be the same as or similar to ICM 620 of system 600 as described in greater detail below with reference to FIG. 6, or may be the same as or similar to controller 856 of fire suppression system 800 as described in greater detail below with reference to FIG. 5. In some embodiments, sensors 30 are the same as or similar to any of the fire detection devices 632 of system 600 as described in greater detail below with reference to FIG. 6, or the temperature sensor 858 of fire suppression system 800 as described in greater detail below with reference to FIG. 5. Similarly, the fire suppression apparatuses 20 can be the same as or similar to the storage tank 614, and any of the devices, nozzles, tubular members, conduits, activation devices, etc., of system 600 that are used to provide the fire suppressant agent to an area, as described in greater detail below with reference to FIG. 6.

Referring particularly to FIG. 2, vehicle system 100 can include multiple battery racks 16. For example, vehicle system 100 can include n battery racks 16. In some embodiments, the n battery racks 16 are positioned within a housing 32 (e.g., an enclosure, a container, etc., of the vehicle 11). In some embodiments, if the battery racks 16 are positioned within housing 32, air sampling detectors 24a can be positioned outside of the housings 17 of each battery rack 16, but within housing 32. For example, air sampling detectors 24a can be fixedly coupled with an exterior surface of housings 17. In some embodiments, fire suppression system 10 includes multiple air sampling detectors 24a. For example, fire suppression system 10 can include an air sampling detector 24a for each battery rack 16.

In some embodiments, the volume of air sample drawn from battery racks 16 is substantially uniform. For example, each air sampling detector 24a may draw a volume of air Vₛₐₘₚₗₑ from the corresponding battery rack 16. In some embodiments, air sampling detector 24a uses the known volume of the air sample drawn from battery racks 16 to determine the concentration of off-gas in the corresponding battery rack 16. Air sampling detectors 24a can be positioned within the housings 17 of their corresponding battery rack 16, or may be positioned within housing 32. In some embodiments, each air sampling detector 24a is configured to provide an off-gas sensor signal to control panel 12.

It should be understood that while FIGS. 1-2 show various embodiments of vehicle system 100, any of the devices, components, functionality, etc., of vehicle system 100 as shown in FIGS. 1-2 can be combined. For example, smoke detector 22 of the embodiment of vehicle system 100 shown in FIG. 1 may be integrated into or included in the embodiment of vehicle system 100 as shown in FIG. 2 and described in greater detail above.

### Control Panel

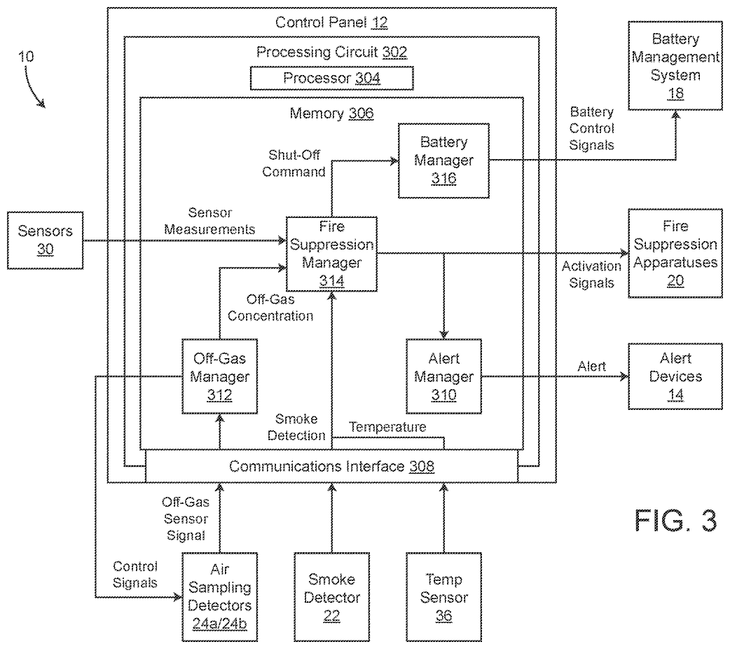

Referring now to FIG. 3, control panel 12 is shown in greater detail, according to some embodiments. In some embodiments, control panel 12 is configured to receive various sensor signals and determine if one or more of fire suppression apparatuses 20 should be activated based on the received sensor signals. Any of the functionality of control panel 12 as described herein with reference to FIG. 3 can be performed by ICM 620 or controller 856 as described in greater detail below with reference to FIGS. 6 and 5, respectively. For example, the functionality of control panel 12 as described herein can be distributed across multiple devices or by a single controller. In some embodiments, the fire suppression apparatuses 20 are a centralized fire suppression system of the vehicle 11. In some embodiments, if the control panel 12 detects or determines that a fire condition is present, the control panel 12 can alert a central fire suppression system of the vehicle 11. For example, the control panel 12 can provide a notification or alarm to the central fire suppression system of the vehicle 11, a central control system of the vehicle 11, a vehicle operator, etc.

Control panel 12 can be a controller and is shown to include a processing circuit 302 including a processor 304 and memory 306. Processor 304 may be a general purpose or specific purpose processor, an application specific integrated circuit (ASIC), one or more field programmable gate arrays (FPGAs), a group of processing components, or other suitable processing components. Processor 304 is configured to execute computer code or instructions stored in memory 306 or received from other computer readable media (e.g., CDROM, network storage, a remote server, etc.).

Memory 306 may include one or more devices (e.g., memory units, memory devices, storage devices, etc.) for storing data and/or computer code for completing and/or facilitating the various processes described in the present disclosure. Memory 306 may include random access memory (RAM), read-only memory (ROM), hard drive storage, temporary storage, non-volatile memory, flash memory, optical memory, or any other suitable memory for storing software objects and/or computer instructions. Memory 306 may include database components, object code components, script components, or any other type of information structure for supporting the various activities and information structures described in the present disclosure. Memory 306 may be communicably connected to processor 304 via processing circuit 302 and may include computer code for executing (e.g., by processor 304) one or more processes described herein. When processor 304 executes instructions stored in memory 306, processor 304 generally configures control panel 12 (and more particularly processing circuit 302) to complete such activities.

In some embodiments, control panel 12 includes a communications interface 308 (e.g., a USB port, a wireless transceiver, etc.) configured to receive and transmit data. Communications interface 308 may include wired or wireless communications interfaces (e.g., jacks, antennas, transmitters, receivers, transceivers, wire terminals, etc.) for conducting data communications external systems or devices. In various embodiments, the communications may be direct (e.g., local wired or wireless communications) or via a communications network (e.g., a WAN, the Internet, a cellular network, etc.). For example, communications interface 308 can include a USB port or an Ethernet card and port for sending and receiving data via an Ethernet-based communications link or network. In another example, communications interface 308 can include a Wi-Fi transceiver for communicating via a wireless communications network or cellular or mobile phone communications transceivers. In some embodiments, communications interface 308 facilitates wired or wireless communications between control panel 12 and air sampling detector 24a (and/or air sampling detector 24b), smoke detector 22, temperature sensor 36, battery management system 18, fire suppression apparatuses 20, alert devices 14, and/or sensors 30.

Referring still to FIG. 3, memory 306 is shown to include an off-gas manager 312, a fire suppression manager 314, an alert manager 310, and a battery manager 316. In some embodiments, off-gas manager 312 is configured to process or analyze sensor data or sensor signals received from any of the air sampling detectors 24a or air sampling detector 24b to determine if off-gas is present at any of battery racks 16 or to determine a concentration of off-gas within battery racks 16 (or a concentration of off-gas in the ambient using the signals obtained from air sampling detector 24b). In some embodiments, fire suppression manager 314 is configured to use the off-gas concentration and/or the detected presence of off-gas in battery racks 16 to determine if fire suppression apparatuses 20 should be activated, to determine if battery management system 18 should be shut-off, to determine if an alert should be provided via alert devices 14. In some embodiments, fire suppression manager 314 is configured to use sensor data obtained by smoke detector 22 and/or temperature sensor 36 in addition to the off-gas detection to determine if fire suppression apparatuses 20 should be activated. Alert manager 310 is configured to cooperatively function with fire suppression manager 314 to provide an appropriate alert or alarm. Battery manager 316 is configured to use any of the outputs of fire suppression manager 314 (e.g., a shut-off command, a fire detection, a rise in temperature, etc.) to provide battery control signals to battery management system 18.

Referring still to FIG. 3, off-gas manager 312 is shown receiving the off-gas sensor signals from air sampling detector 24a. In some embodiments, off-gas manager 312 is configured to receive the off-gas sensor signals from air sampling detector 24a and determine if off-gas is present within the corresponding battery rack 16. In some embodiments, off-gas manager 312 provides fire suppression manager 314 with an indication of whether or not off-gas is present/detected within the corresponding battery rack 16 as well as which of battery racks 16 the indication corresponds to. For example, a binary decision variable dⱼ for the jth battery rack 16 may have a value of 1, indicating that off-gas is currently detected in the jth battery rack 16, or a value of 0, indicating that off-gas is not currently detected in the jth battery rack 16. In this case, off-gas manager 312 can provide a value of the decision variable d for each battery rack 16. For example, the first battery rack 16 may have an associated decision variable d₁, the second battery rack 16 may have an associated decision variable d₂, etc., and the nth battery rack 16 may have an associated decision variable dₙ.

In some embodiments, off-gas manager 312 is configured to use the off-gas sensor signals received from any of the air sampling detectors 24a to identify a concentration of off-gas in the associated battery rack 16. For example, off-gas manager 312 can determine a concentration Cⱼ of the jth battery rack 16. In this way, if n battery racks 16 are used, off-gas manager 312 can use the received off-gas sensor signals to identify values of C₁, C₂, . . . , Cₙ, where C₁ is the detected concentration of off-gas in the first battery rack 16, C₂ is the detected concentration of off-gas in the second battery rack 16, etc., and Cₙ is the detected concentration of off-gas in the nth battery rack 16. In some embodiments, the concentrations have values of parts per million (e.g., Cⱼ=off-gas ppm), a ratio of a volume V_{gas} of the detected off-gas to the volume of the air sample

$${V}_{sample} ( e . g . , {C}_{j} = \frac{{V}_{gas , j}}{{V}_{sample}} ) ,$$

a ratio of a mass m_{gas} of the detected off-gas to mass of the air sample

$${m}_{sample} ( e . g . , {C}_{j} = \frac{{m}_{gas , j}}{{m}_{sample}} ) ,$$

etc. In some embodiments, the concentration indicates a ratio of an amount of the off-gas in the sample to the total amount of the air sample.

In some embodiments, air sampling detector 24b provides off-gas sensor signal(s) for detection of a concentration or presence of off-gas in ambient or surrounding areas. The concentration or presence of off-gas may indicate a reference or baseline concentration of off-gas (e.g., outside of battery rack(s) 16). Off-gas manager 312 can compare concentrations of off-gas of the battery racks 16 (e.g., the concentration Cⱼ) to concentration of off-gas in the ambient or surrounding areas (e.g., a concentration C_{amb}) to determine a difference (e.g., ΔCⱼ) between the concentration of off-gas at the battery racks 16 (e.g., Cⱼ) and the concentration of off-gas in the ambient or surrounding areas. In some embodiments, the difference ΔCⱼ may be used in place of the concentrations Cⱼ (e.g., by off-gas manager 312, by fire suppression manager 314, by alert manager 310, by battery manager 316, etc.).

In some embodiments, fire panel 12 is configured to monitor any of, or any combination of the concentrations Cⱼ, the ambient concentration C_{amb}, or the difference(s) ΔCⱼ in real-time. Fire panel 12 (e.g., off-gas manager 312) can be configured to detect changes in any of the of the concentrations Cⱼ, the ambient concentration C_{amb}, or the difference(s) ΔCⱼ of less than 1 ppm.

In some embodiments, off-gas manager 312 provides any of the concentrations C₁, C₂, . . . , Cₙ of then battery racks 16 to fire suppression manager 314. In some embodiments, fire suppression manager 314 is configured to analyze the off-gas concentrations to identify if a fire is likely to occur in the near-future at any of battery racks 16 of vehicle 11. Fire suppression manager 314 can receive the concentrations from off-gas manager 312 and compare the concentrations to a threshold concentration value C_{threshold} In some embodiments, the threshold concentration value C_{threshold} is a predetermined value that indicates whether a significant amount of off-gas are present in battery rack 16. In some embodiments, C_{threshold} is equal to zero or substantially equal to zero, such that fire suppression manager 314 determines that a fire is likely to occur at battery rack 16 in response to any amount of off-gas being detected in battery rack 16.

In response to any of the concentrations C₁, C₂, . . . , Cₙ exceeding the threshold concentration value C_{threshold}, fire suppression manager 314 can determine that a fire is likely to occur in the near future at the corresponding battery rack 16. In response to determining that a fire is likely to occur in the near future at the corresponding battery rack 16, fire suppression manager 314 can generate activation signals (e.g., fire suppression release signals) and provide the activation signals to fire suppression apparatuses 20 to activate fire suppression apparatuses 20 and discharge the fire suppressant agent to suppress or prevent the fire from occurring. If none of the concentrations of off-gas in any of battery racks 16 exceeds the threshold concentration value C_{threshold}, fire suppression manager 314 does not activate fire suppression apparatuses 20 and continues periodically checking the concentrations of off-gas as provided by off-gas manager 312.

In some embodiments, fire suppression manager 314 is configured to receive smoke detection signals and temperature signals from smoke detector 22 and temperature sensor 36, respectively. Fire suppression manager 314 can use the smoke detection and the temperature at any of battery racks 16 to determine if a fire has occurred or is likely to occur. Fire suppression manager 314 can compare the temperature at each battery rack 16 to a corresponding threshold temperature to determine if a fire has occurred or if a fire is likely to occur in the near future. In some embodiments, fire suppression manager 314 activates fire suppression apparatuses 20 in response to the temperature at any of battery racks 16 exceeding the threshold temperature value or in response to the smoke detection indicating that smoke is present in any of battery racks 16.

In some embodiments, fire suppression manager 314 receives sensed temperature values associated with each battery rack 16 from temperature sensor 36. Fire suppression manager 314 can determine a rate of change of the temperature \dot{T}_{rack} over time. In some embodiments, if the rate of change of the temperature \dot{T}_{rack} exceeds a corresponding temperature rate of change threshold value \dot{T}_{threshold} for a predetermined time duration Δt (e.g., if the temperature at one of battery racks 16 is increasing rapidly over the predetermined time duration), fire suppression manager 314 may determine that a fire is likely to occur at one of battery racks 16 and may activate fire suppression apparatuses 20 to prevent the fire from occurring or to suppress if the fire if it has already occurred.

In this way, fire suppression manager 314 can use the off-gas concentrations, smoke detection, and temperature to preemptively activate fire suppression apparatuses 20 to prevent a fire from occurring at battery racks 16 of vehicle 11. In some embodiments, vehicle system 100 also includes an optical sensor configured to measure heat or light emitted by a fire. In this way, fire suppression manager 314 can receive sensor data from the optical sensor and use the sensor data to determine if a fire has occurred.

In some embodiments, fire suppression manager 314 is configured to obtain sensor measurements from sensors 30. Sensors 30 can be any optical or temperature sensor that is/are positioned at a monitored space, area, component, device, primary mover (e.g., primary mover 54), internal combustion engine, etc., of vehicle 11. For example, sensors 30 can be positioned at areas or zones of vehicle 11 where fuel may be present, and therefore where combustion is possible. In some embodiments, sensors 30 are configured to measure the temperature and/or light intensity of any areas of vehicle 11 to be monitored (e.g., locations of vehicle 11 where fire may occur other than battery racks 16). In some embodiments, sensors 30 are communicably coupled with fire suppression manager 314 via communications interface 308. For example, sensors 30 can be configured to communicate with fire suppression manager 314 by a technician via plug and play. The technician may mount, fixedly couple, position, etc., any of the sensors 30 at an area or zone of vehicle 11 to be monitored, and may communicably couple sensors 30 with control panel 12 via electrical cables. In some embodiments, sensors 30 are configured to communicate with control panel 12 to provide their sensor measurements (e.g., temperature measurements, optical measurements, infrared measurements, heat measurements, etc.) to fire suppression manager 314 wirelessly.

Fire suppression manager 314 can use the sensor measurements to determine if a fire has occurred at any of the monitored spaces (e.g., the areas, devices, components of vehicle 11, etc., monitored by sensors 30 other than battery racks 16), or to determine if a fire has occurred or is likely to occur at battery racks 16. In some embodiments, fire suppression manager 314 is configured to activate any of fire suppression apparatuses 20 in response to determining that a fire has occurred at any of the monitored areas (e.g., using the sensor measurements, and/or the off-gas concentrations). In some embodiments, fire suppression manager 314 is configured to provide activation signals to various fire suppression apparatuses 20 based on a location of the detected fire. For example, if fire suppression manager 314 determines, based on the off-gas concentration that a fire is likely to occur at battery racks 16, but that a fire has not occurred at the areas of vehicle 11 monitored by sensors 30, fire suppression manager 314 may activate fire suppression apparatuses 20 that are configured to provide fire suppression for battery racks 16 without activating other fire suppression apparatuses 20. Likewise, if fire suppression manager 314 determines that a fire has occurred at any of the areas monitored by sensors 30, but that a fire has not occurred or is not predicted to occur at battery racks 16, fire suppression manager 314 can activate the fire suppression apparatuses 20 that are configured to provide fire suppression for the areas monitored by sensors 30 but not for the battery racks 16.

In some embodiments, fire suppression system 10 includes multiple types of fire suppression apparatuses 20. For example, the fire suppression apparatuses 20 that are configured to provide fire suppression for battery racks 16 may be inert-gas based devices, that are configured to deliver, provide, flood, etc., an inert gas to battery racks 16. In some embodiments, the fire suppression apparatuses 20 associated with the battery racks 16 are configured to provide an inert gas to the internal volume of battery racks 16 (e.g., the internal volume defined by housing 17 of battery racks 16). In some embodiments, the fire suppression apparatuses 20 that are associated with battery racks 16 are configured to provide the inert gas the an internal volume of housing 32.

In some embodiments, the fire suppression apparatuses 20 that are configured to provide fire suppression for the areas monitored by sensors 30 (e.g., areas of vehicle 11 other than the battery racks 16 such as an engine bay, a fuel system, etc.)

In some embodiments, the battery racks 16 are also associated with one or more fire suppression apparatuses 20. For example, each battery rack 16 may be associated with a fire suppression apparatus 20 that is configured to deliver an inert gas in addition to a fire suppression apparatus 20 that is configured to apply a foam fire suppressant agent. In some embodiments, fire suppression manager 314 operates both the inert gas fire suppression apparatus 20 and the foam fire suppression apparatus 20 to suppress fire, or prevent the occurrence of a fire at battery rack(s) 16. For example, fire suppression manager 314 can activate the inert gas fire suppression apparatus 20 first, and then activate the foam fire suppression apparatus 20. In this way, fire suppression system 10 can be configured to perform a double-shot fire suppression for battery racks 16 (e.g., by sequentially and/or concurrently activating one or more inert gas fire suppression apparatuses 20, and one or more foam fire suppression apparatuses 20). Advantageously, this may reduce the likelihood of or extinguish fires at battery racks 16.

For example, fire suppression manager 314 may operate one or more fire suppression apparatuses 20 to release an inert gas into or about the battery racks 16 at an initial detection of off-gas in battery rack(s) 16. A second, or multiple discharge can be triggered or initiated by fire suppression manager 314 after the activation of the inert gas fire suppression apparatuses 20 to provide any number of fire suppressant agents into battery rack 16, or into housing 32 (e.g., a chemical agent, water, a foam agent, etc.) to facilitate rapid heat removal in the battery racks 16 or in the housing 32.

Fire suppression manager 314 can also provide a shut-off command to battery manager 316. In some embodiments, fire suppression manager 314 provides a shut-off command to battery manager 316 if activation signals are provided to fire suppression apparatuses 20, or if fire suppression manager 314 determines that the temperature is increasing at a rate above the temperature rate of change threshold value. In this way, battery manager 316 may generate battery control signals to shut-off battery racks 16 concurrently with activating fire suppression apparatuses 20 (e.g., in response to a fire being detected, or in response to fire suppression manager 314 determining that a fire is likely to occur in the near future). Likewise, fire suppression manager 314 can provide the shut-off command to battery manager 316 if the temperature at battery racks 16 exceeds a maximum allowable temperature (e.g., the threshold temperature value). In some embodiments, fire suppression manager 314 provides the shut-off command to battery manager 316 without providing activation signals to fire suppression apparatuses 20. For example, if the temperature at battery racks 16 begins increasing at a rapid pace (e.g., above a corresponding rate of change threshold value) for at least a time interval or if the temperature at battery racks 16 exceeds the maximum allowable temperature, fire suppression manager 314 may provide the shut-off command to battery manager 316 without providing the activation signals to fire suppression apparatuses 20. In this way, battery manager 316 may shut-off battery racks 16 without activation of fire suppression apparatuses 20.

Battery manager 316 receives the shut-off command from fire suppression manager 314 and provides battery control signals to battery management system 18, battery racks 16, or a switch. In some embodiments, battery management system 18 shuts off battery racks 16 so that power cannot be drawn from the battery cells of battery racks 16 in response to receiving shut-off control signals. In some embodiments, all of battery racks 16 are shut off. In some embodiments, particular battery racks 16 are shut off which are associated with high temperatures (e.g., temperatures exceeding the maximum allowable temperature) or rapidly increasing temperatures (e.g., temperatures that are increasing at a rate greater than a maximum rate of change threshold).

Fire suppression manager 314 can also provide an indication to alert manager 310 regarding operations performed in response to detecting a fire or in response to determining that a fire is likely to occur in the near future. For example, if fire suppression manager 314 provides activation signals to fire suppression apparatuses 20, fire suppression manager 314 may also notify alert manager 310 that fire suppression apparatuses 20 has been activated. In some embodiments, if fire suppression manager 314 activates fire suppression apparatuses 20 to preemptively suppress a fire at battery racks, fire suppression manager 314 also provides alert manager 310 with an indication that fire suppression apparatuses 20 is being activated preemptively. Likewise, if fire suppression manager 314 activates fire suppression apparatuses 20 due to a fire occurring at battery racks 16, fire suppression manager 314 may also notify alert manager 310 that fire suppression apparatuses 20 was activated due to the occurrence of a fire. Additionally, fire suppression manager 314 can provide alert manager 310 with a notification of whether or not the shut-off command was provided to battery manager 316 or with a notification of which battery racks 16 were shut off.

Alert manager 310 receives the notifications of any of the operations of fire suppression manager 314 and provides an appropriate alert. Alert manager 310 can provide an alert to an operator of vehicle 11 via alert devices 14 (e.g., a visual alert, an aural alert, etc.). In some embodiments, alert manager 310 provides different alerts or provides alerts to certain devices/systems based on the notifications of the operations received from fire suppression manager 314. In some embodiments, the alerts provided to the operator via alert devices 14 include the notifications received from fire suppression manager 314 and/or the reasons for why the various operations were performed. For example, alert manager 310 can alert the operator that a fire was detected at the first battery rack 16 and that the battery racks 16 were shut off and fire suppression apparatuses 20 have been activated in response to the fire. Likewise, alert manager 310 can alert the operator via alert devices 14 that battery racks 16 were shut off due to high temperatures but that fire suppression apparatuses 20 were not activated.

Alert devices 14 can also be or include a display screen configured to provide a status of battery management system 18, temperature detection at battery racks 16, smoke detection in battery racks 16, off-gas detection in battery racks 16, rate of change of temperature at battery racks 16, sensor measurements obtained by sensors 30, etc. In some embodiments, alert devices 14 are also configured to display a current status of fire suppression apparatuses 20 (e.g., whether or not fire suppression apparatuses 20 has been activated, a time at which fire suppression apparatuses 20 was activated, a reason why fire suppression apparatuses 20 was activated, etc.).

Advantageously, control panel 12 is configured to monitor off-gas concentrations in battery racks 16 (e.g., that are positioned within housing 32) of vehicle 11 and activate fire suppression apparatuses 20 preemptively to reduce the likelihood of a fire occurring and to prevent thermal runaway. Since battery fires can be particularly difficult to extinguish after combustion, preemptively detecting and responding to fires by monitoring the off-gas emitted by the battery cells of battery racks 16 reduces the likelihood of a fire occurring, thereby reducing the likelihood that battery racks 16 or surrounding objects (e.g., various components of vehicle 11) are destroyed or damaged due to a fire occurrence.

### Battery Fire Suppression Process

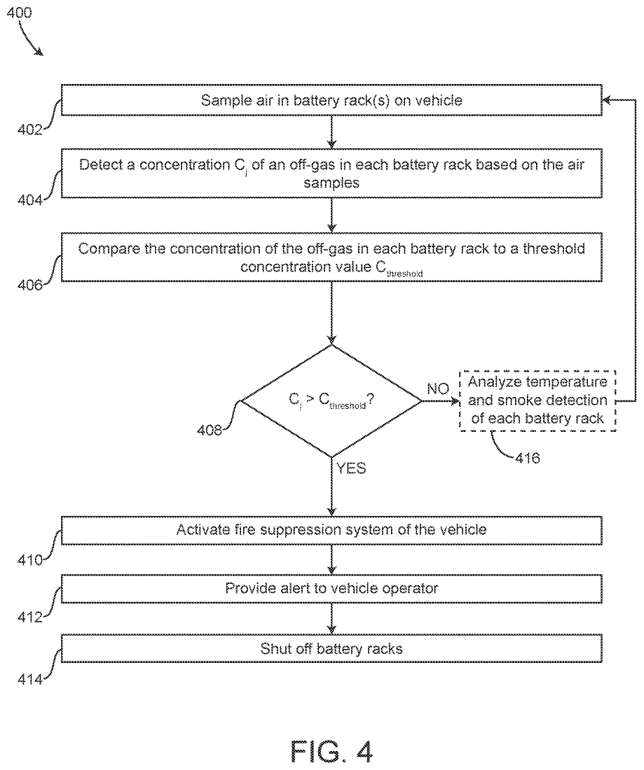

Referring now to FIG. 4, a process 400 for monitoring battery racks of a vehicle and preemptively responding to various conditions at the battery racks to prevent combustion is shown, according to some embodiments. Process 400 includes steps 402-416 and may be performed by vehicle system 100, fire suppression system 10, control panel 12, and/or the various components thereof. Advantageously, process 400 can be performed to monitor off-gas emitted by failing battery cells and thereby prevent thermal runaway and combustion of the battery cells.

Process 400 includes sampling air in battery racks on a vehicle (step 402), according to some embodiments. In some embodiments, step 402 is performed by air sampling detectors 24a. In some embodiments, step 402 is performed by off-gas manager 312 and/or air sampling detector 24a. In some embodiments, air sampling detectors 24a are positioned within housing 17 of battery racks 16 or within housing 32 so that air sampling detectors 24a can obtain and analyze air samples. In other embodiments, step 402 is performed by receiving air samples from within each of battery racks 16 if there is a forced airflow through battery racks 16.

Process 400 includes detecting a concentration Cⱼ of an off-gas in each battery rack based on the air samples (step 404), according to some embodiments. In some embodiments, step 404 is performed by air sampling detector 24a. In some embodiments, step 404 includes identifying a concentration of one or more of a variety of gasses that are emitted by battery cells as they begin to fail. The concentration can be measured or detected in units of parts per million (ppm), percent concentration, a ratio between the volume of the off-gas and the air sample, etc. In some embodiments, off-gas manager 312 is configured to receive sensor signals from air sampling detector 24a and use the sensor signals to identify the concentration of off-gas in the air sample.

Process 400 includes comparing the concentration Cⱼ of the off-gas in each battery rack to a threshold concentration value C_{threshold} (step 406) and determining if the concentration Cⱼ of the off-gas in each battery rack exceeds the threshold concentration value C_{threshold} (step 408), according to some embodiments. In some embodiments, steps 406 and 408 are performed by fire suppression manager 314 to determine if fire suppression apparatuses 20 should be activated. In some embodiments, the threshold concentration value C_{threshold} is a maximum allowable threshold value. Values above the threshold concentration value C_{threshold} can indicate that the battery cells 19 of a particular battery rack 16 are emitting off-gasses and are in the process of failing. In some embodiments, the threshold concentration value C_{threshold} has a value of zero so that any amount of off-gas triggers off-gas detection and fire suppression response. In some embodiments, the threshold concentration value C_{threshold} is a value determined based on empirical testing. Process 400 proceeds to step 410 in response to the concentration of the off-gas in battery rack 16 exceeding the threshold concentration value C_{threshold}, according to some embodiments. In some embodiments, process 400 proceeds to step 410 in response to the concentration of the off-gas in battery rack 16 being substantially equal to the threshold concentration value C_{threshold} In some embodiments, process 400 proceeds to step 416 (or returns to step 402) in response to the concentration of off-gas in battery rack 16 being less than the threshold concentration value C_{threshold}.

Process 400 includes activating the fire suppression system or fire suppression apparatuses of the vehicle (step 410) in response to the concentration or level of off-gas in battery rack 16 being greater than (or greater than or equal to) the threshold concentration value C_{threshold}, according to some embodiments. In some embodiments, step 410 includes activating fire suppression apparatuses 20 to provide fire suppressant agent to battery racks 16 (e.g., within housing 32). In some embodiments, step 410 includes fluidly coupling housing 32 with one or more fire suppression apparatuses 20 such that fire suppressant agent can be provided to an internal volume of housing 17 and/or housing 32. In some embodiments, step 410 includes performing a “double” or “multi” shot fire suppression operation to suppress, prevent, extinguish, etc., a fire at the one or more battery racks. For example, step 410 can include activating a first fire suppression apparatus or a first set of components of the fire suppression system to provide an inert gas to the battery racks. After the inert gas is provided to the battery racks, step 410 can include activating a second one or more fire suppression apparatuses or components of the fire suppression system to provide a fire suppressant agent to the battery racks other than an inert gas (e.g., a chemical fire suppressant agent, a foam fire suppressant agent, water, etc.). In some embodiments, the various fire suppression apparatuses are activated at least concurrently so that one or more types of fire suppressant agent are provided to the battery racks simultaneously.

Process 400 includes providing an alert to a vehicle operator (step 412), according to some embodiments. In some embodiments, step 412 includes providing the alert to the vehicle operator via alert device(s) 14. In some embodiments, the alert includes an indication of whether or not fire suppression apparatuses 20 have been activated and/or whether or not battery racks 16 have been shut-down. In some embodiments, step 412 is performed by alert manager 310. In some embodiments, step 412 includes operating alert devices 14 to provide a visual and/or an aural alert. In this way, if off-gas is detected, the vehicle operator can be alerted by operation of alert devices 14.

Process 400 includes shutting off the battery racks (step 414), according to some embodiments. In some embodiments, step 414 is performed by battery manager 316. In some embodiments, step 414 includes operating battery racks 16 such the battery cells do not provide power to an end user or for an end use (e.g., to operate various systems, primary movers, electric motors, etc., of vehicle 11). In some embodiments, any of steps 410-414 are performed concurrently. In some embodiments, the alert provided in step 412 includes an indication of a status of battery racks 16 (e.g., whether or not battery racks 16 are shut-off/deactivated).

Process 400 includes analyzing temperature and smoke detection of each battery rack (step 416), according to some embodiments. In some embodiments, step 416 includes receiving smoke detection and/or temperature sensor feedback from smoke detector 22 and/or temperature sensor 36 at battery rack 16. In some embodiments, step 416 is performed by fire suppression manager 314 and includes comparing the smoke detection or the temperature to a corresponding threshold value. In some embodiments, step 416 is optional. If the smoke detection and/or the temperature indicates a fire (e.g., if smoke is detected or if the temperature exceeds a threshold value), process 400 may proceed to step 410 and activate fire suppression apparatuses 20 to suppress the fire. If the smoke detection and/or the temperature does not indicate a fire (e.g., if smoke is not detected and if the temperature does not exceed the threshold value) or a fire condition, process 400 returns to step 402.

### Fire Suppression Apparatuses and Systems

Referring to FIG. 5, a fire suppression system 800 is shown according to an exemplary embodiment. In some embodiments, fire suppression system 800 is usable on a vehicle (e.g., vehicle 11) with control panel 12. For example, fire suppression system 800 can be configured to provide fire suppressant agent to battery rack(s) 16 (e.g., into the housing 17, or into the housing 32). In one embodiment, fire suppression system 800 is a chemical fire suppression system. Fire suppression system 800 is configured to dispense or distribute a fire suppressant agent onto and/or nearby a fire, extinguishing the fire and preventing the fire from spreading. Fire suppression system 800 may be used alone or in combination with other types of fire suppression systems (e.g., a building sprinkler system, a handheld fire extinguisher, etc.). In some embodiments, multiple fire suppression systems 10 are used in combination with one another to cover a larger area (e.g., each in different rooms of a building). In a preferred embodiment, fire suppression system 800 is a gaseous fire suppression system that uses a gaseous fire suppressant agent (e.g., an inert or chemical gaseous fire suppressant agent).

Fire suppression system 800 may be used in a variety of different applications. Different applications may require different types of fire suppressant agent and different levels of mobility. Fire suppression system 800 is usable with a variety of different fire suppressant agents, such as powders, liquids, foams, or other fluid or flowable materials. Fire suppression system 800 may be used in a variety of stationary applications. By way of example, fire suppression system 800 is usable in kitchens (e.g., for oil or grease fires, etc.), in libraries, in data centers (e.g., for electronics fires, etc.), at filling stations (e.g., for gasoline or propane fires, etc.), or in other stationary applications. Alternatively, fire suppression system 800 may be used in a variety of mobile applications. By way of example, fire suppression system 800 may be incorporated into land-based vehicles (e.g., racing vehicles, forestry vehicles, construction vehicles, agricultural vehicles, mining vehicles, passenger vehicles, refuse vehicles, etc.), airborne vehicles (e.g., jets, planes, helicopters, etc.), or aquatic vehicles, (e.g., ships, submarines, etc.).

Referring still to FIG. 5, fire suppression system 800 includes a fire suppressant tank 812 (e.g., a vessel, container, vat, drum, tank, canister, pressure vessel, cartridge, or can, etc.). Fire suppressant tank 812 defines an internal volume 814 filled (e.g., partially, completely, etc.) with fire suppressant agent. In some embodiments, the fire suppressant agent is normally not pressurized (e.g., is near atmospheric pressure). Fire suppressant tank 812 includes a neck 816 (e.g., an exchange section). Neck 816 permits the flow of expellant gas into internal volume 814 and the flow of fire suppressant agent out of internal volume 814 so that the fire suppressant agent may be supplied to a fire.

Fire suppression system 800 further includes a cartridge 820 (e.g., a vessel, container, vat, drum, tank, canister, pressure vessel, cartridge, or can, etc.). Cartridge 820 defines an internal volume 822 configured to contain a volume of pressurized expellant gas. The expellant gas may be an inert gas. In some embodiments, the expellant gas is air, carbon dioxide, or nitrogen. Cartridge 820 includes a neck 824 (e.g., an outlet portion or outlet section). Neck 824 defines an outlet fluidly coupled to internal volume 822. Accordingly, the expellant gas may leave cartridge 820 through neck 824. Cartridge 820 may be rechargeable or disposable after use. In some embodiments where cartridge 820 is rechargeable, additional expellant gas may be supplied to internal volume 822 through neck 824.

Fire suppression system 800 further includes an actuator 830 (e.g., a valve, puncture device, or activator assembly). Actuator 830 includes a receiver 832 (e.g., an adapter, a coupler, an interfacing member, a receiving member, an engagement member, etc.), that is configured to receive neck 824 of cartridge 820. Neck 824 is selectively coupled to the receiver 832 (e.g., through a threaded connection, etc.). Decoupling cartridge 820 from actuator 830 facilitates removal and replacement of cartridge 820 when cartridge 820 is depleted. Actuator 830 is fluidly coupled to neck 816 of fire suppressant tank 812 through a hose 834 (e.g., a conduit, tubular member, pipe, fixed pipe, piping system, etc.).

Actuator 830 includes an activation mechanism 836 configured to selectively fluidly couple internal volume 822 to neck 816. In some embodiments, activation mechanism 836 includes one or more valves that selectively fluidly couple internal volume 822 to hose 834. The valves may be mechanically, electrically, manually, or otherwise actuated. In some such embodiments, neck 824 includes a valve that selectively prevents the expellant gas from flowing through neck 824. Such a valve may be manually operated (e.g., by a lever or knob on the outside of cartridge 820, etc.) or may open automatically upon engagement of neck 824 with actuator 830. Such a valve facilitates removal of cartridge 820 prior to depletion of the expellant gas. In other embodiments, cartridge 820 is sealed, and activation mechanism 836 includes a pin, knife, nail, or other sharp object that actuator 830 forces into contact with cartridge 820. This punctures the outer surface of cartridge 820, fluidly coupling internal volume 822 with actuator 830. In some embodiments, activation mechanism 836 punctures cartridge 820 only when actuator 830 is activated. In some such embodiments, activation mechanism 836 omits any valves that control the flow of expellant gas to hose 834. In other embodiments, activation mechanism 836 automatically punctures cartridge 820 as neck 824 engages actuator 830.

Once actuator 830 is activated and cartridge 820 is fluidly coupled to hose 834, the expellant gas from cartridge 820 flows freely through neck 824, actuator 830, and hose 834 and into neck 816. The expellant gas forces fire suppressant agent from fire suppressant tank 812 out through neck 816 and into a pipe 840 (e.g., a conduit or hose). In one embodiment, neck 816 directs the expellant gas from hose 834 to a top portion of internal volume 814. Neck 816 defines an outlet (e.g., using a syphon tube, etc.) near the bottom of fire suppressant tank 812. The pressure of the expellant gas at the top of internal volume 814 forces the fire suppressant agent to exit through the outlet and into pipe 840. In other embodiments, the expellant gas enters a bladder within fire suppressant tank 812, and the bladder presses against the fire suppressant agent to force the fire suppressant agent out through neck 816. In yet other embodiments, pipe 840 and hose 834 are coupled to fire suppressant tank 812 at different locations. By way of example, hose 834 may be coupled to the top of fire suppressant tank 812, and pipe 840 may be coupled to the bottom of fire suppressant tank 812. In some embodiments, fire suppressant tank 812 includes a burst disk that prevents the fire suppressant agent from flowing out through neck 816 until the pressure within internal volume 814 exceeds a threshold pressure. Once the pressure exceeds the threshold pressure, the burst disk ruptures, permitting the flow of fire suppressant agent. Alternatively, fire suppressant tank 812 may include a valve, a puncture device, or another type of opening device or activator assembly that is configured to fluidly couple internal volume 814 to pipe 840 in response to the pressure within internal volume 814 exceeding the threshold pressure. Such an opening device may be configured to activate mechanically (e.g., the force of the pressure causes the opening device to activate, etc.) or the opening device may include a separate pressure sensor in communication with internal volume 814 that causes the opening device to activate.

Pipe 840 is fluidly coupled to nozzles 842 (e.g., one or more outlets or sprayers such as nozzles, sprinkler heads, discharge devices, dispersion devices, etc.). The fire suppressant agent flows through pipe 840 and to nozzles 842. Nozzles 842 each define one or more apertures, through which the fire suppressant agent exits, forming a spray of fire suppressant agent that covers a desired area. The sprays from nozzles 842 then suppress or extinguish fire within that area. The apertures of nozzles 842 may be shaped to control the spray pattern of the fire suppressant agent leaving nozzles 842. Nozzles 842 may be aimed such that the sprays cover specific points of interest (e.g., a specific piece of restaurant equipment, a specific component within an engine compartment of a vehicle, etc.). Nozzles 842 may be configured such that all of nozzles 842 activate simultaneously, or nozzles 842 may be configured such that only nozzles 842 near the fire are activated.

Fire suppression system 800 further includes an automatic activation system 850 that controls the activation of actuator 830. Automatic activation system 850 is configured to monitor one or more conditions and determine if those conditions are indicative of a nearby fire. Upon detecting a nearby fire, automatic activation system 850 activates actuator 830, causing the fire suppressant agent to leave nozzles 842 and extinguish the fire.

In some embodiments, actuator 830 is controlled mechanically. As shown in FIG. 5, automatic activation system 850 includes a mechanical system including a cable 852 (e.g., a tensile member such as a rope, a cable, etc.), that imparts a tensile force on actuator 830. Without this tensile force, actuator 830 will activate. Cable 852 is coupled to a fusible link 854, which is in turn coupled to a stationary object (e.g., a wall, the ground, etc.). The fusible link 854 includes two plates that are held together with a solder alloy having a predetermined melting point. A first plate is coupled to cable 852, and a second plate is coupled to the stationary object. When the ambient temperature surrounding the fusible link 854 exceeds the melting point of the solder alloy, the solder melts, allowing the two plates to separate. This releases the tension on cable 852, and actuator 830 activates. In other embodiments, automatic activation system 850 is another type of mechanical system that imparts a force on actuator 830 to activate actuator 830. Automatic activation system 850 may include linkages, motors, hydraulic or pneumatic components (e.g., pumps, compressors, valves, cylinders, hoses, etc.), or other types of mechanical components configured to activate actuator 830. Some parts of automatic activation system 850 (e.g., a compressor, hoses, valves, and other pneumatic components, etc.) may be shared with other parts of fire suppression system 800 (e.g., manual activation system 860) or vice versa.

Actuator 830 may additionally or alternatively be configured to activate in response to receiving an electrical signal from automatic activation system 850. Referring to FIG. 5, automatic activation system 850 includes a controller 856 that monitors signals from one or more temperature sensors 858 (e.g., fire detectors or sensors such as thermocouples, resistance temperature detectors, etc.). Controller 856 may use the signals from the temperature sensor 858 to determine if an ambient temperature has exceeded a threshold temperature. Upon determining that the ambient temperature has exceeded the threshold temperature, controller 856 provides an electrical signal to actuator 830. Actuator 830 then activates in response to receiving the electrical signal.

Fire suppression system 800 further includes a manual activation system 860 that controls the activation of actuator 830. Manual activation system 860 is configured to activate actuator 830 in response to an input from an operator. Manual activation system 860 may be included in addition to automatic activation system 850. Both automatic activation system 850 and manual activation system 860 may activate actuator 830 independently. By way of example, automatic activation system 850 may activate actuator 830 regardless of any input from manual activation system 860.

As shown in FIG. 5, manual activation system 860 includes a mechanical system including a cable 862 (e.g., a tensile member such as a rope, a cable, etc.), coupled to actuator 830. Cable 862 is coupled to a button 864 (e.g., a human interface device such as a button, a lever, a switch, a knob, a pull ring, etc.). Button 864 is configured to impart a tensile force on cable 862 when pressed, and this tensile force is transferred to actuator 830. Actuator 830 activates upon experiencing the tensile force. In other embodiments, manual activation system 860 is another type of mechanical system that imparts a force on actuator 830 to activate actuator 830. Manual activation system 860 may include linkages, motors, hydraulic or pneumatic components (e.g., pumps, compressors, valves, cylinders, hoses, etc.), or other types of mechanical components configured to activate actuator 830.

Actuator 830 may additionally or alternatively be configured to activate in response to receiving an electrical signal from manual activation system 860. As shown in FIG. 5, button 864 is operably coupled to controller 856. Controller 856 may be configured to monitor the status of a human interface device or user input device (e.g., engaged, disengaged, etc.). Upon determining that the human interface device is engaged, the controller provides an electrical signal to activate actuator 830. By way of example, controller 856 may be configured to monitor a signal from button 864 to determine if button 864 is pressed. Upon detecting that button 864 has been pressed, controller 856 sends an electrical signal to actuator 830 to activate actuator 830.

Automatic activation system 850 and manual activation system 860 are shown to activate actuator 830 both mechanically (e.g., though application of a tensile force through cables, through application of a pressurized liquid, through application of a pressurized gas, etc.) and electrically (e.g., by providing an electrical signal). It should be understood, however, that automatic activation system 850 and/or manual activation system 860 may be configured to activate actuator 830 solely mechanically, solely electrically, or through some combination of both. By way of example, automatic activation system 850 may omit controller 856 and activate actuator 830 based on the input from the fusible link 854. By way of another example, automatic activation system 850 may omit the fusible link 854 and activate actuator 830 using an input from controller 856.

Referring further to FIG. 5, fire suppression system 800 further includes a canister monitoring system 1000. Canister monitoring system 1000 can be configured to monitor a status of fire suppression system 800 (e.g., to monitor a level of fire suppressant agent in fire suppressant tank 812, to monitor pressure of fire suppressant tank 812 and/or cartridge 820, to monitor placement of installed components of fire suppression system 800, etc.).

In some embodiments, fire suppression apparatuses 20 is a component of fire suppression system 800. Fire suppression apparatuses 20 can include any of the components or devices of fire suppression system 800. For example, fire suppressant tank 812, cartridge 820, hose 834, actuator 830, pipe 840, and nozzles 842 may be fire suppression apparatuses 20.

Referring particularly to FIG. 6, a schematic illustration of a suppression system 600 is shown, according to some embodiments. In some embodiments, system 600 includes a fire suppressant agent supply coupled to a nozzle 612 (e.g., a fixed nozzle) to protect a hazard H or area in which an ignition source and fuel or flammable materials may be found. As shown, the fire suppressant agent supply may include one or more storage tanks or cylinders 614 containing the fire suppressant agent, such as for example a chemical agent. Each storage tank 614 cylinder can include a pressurized cylinder assembly 616 configured for pressurizing the cylinders 614 for delivery of the agent under an operating pressure to the nozzle 612 to address a fire in the hazard H. In some embodiments, the pressurized cylinder assembly 616 includes a rupturing device 616a which punctures a rupture disc of a pressurized cylinder 616b containing a pressurized gas, such as for example nitrogen, to pressurize the storage tank 614 for delivery of the fire suppressant agent.

In order to operate the rupturing device 616a, the system 600 may provide for automatic actuation and manual operation of the rupturing device 616a to provide for respective automated and manual delivery of the chemical agent in response a fire for protection of the hazard H. The preferred rupturing or actuating device or assembly 616a includes a puncturing pin or member that is driven into the rupture disc of the pressurized cylinder 616b for release of the pressurized gas. The puncturing pin of the rupturing device 616a may be driven electrically or pneumatically to puncture the rupture disc of the pressurized cylinder 616b.

The actuating device 616 preferably includes a protracted actuation device (PAD) 618 for driving the puncturing pin of the assembly into the rupture disc. The PAD 618 generally includes an electrically coupled rod or member that is disposed above the puncturing pin. When an electrical signal is delivered to the PAD 618, the rod of the PAD is driven directly or indirectly into the puncturing pin which punctures the rupture disc of the pressurized cylinder 616b. A preferred pressurized cylinder assembly is shown in Form No. F-956143-05 which is attached to U.S. Provisional Patent Application No. 61/704,551 and shows a known rupturing device for either manual and pneumatic or automatic electrical operation to drive a puncture pin. The system 600 provides for automatic and manual operation of the PAD 618. Unlike prior industrial/fire suppression systems having PADs and rupture discs, the preferred system 600 provides for electric manual operation of the PAD 618 as explained in greater detail below. The system 600 can further provide for one or more remote manual operating stations 605 to manually actuate the system. As is known in the art, the manual operating stations 605 can rupture a canister of pressurized gas, for example, nitrogen at 1800 psi, to fill and pressurize an actuation line which in turn drives the puncturing pin of the rupturing assembly 616a into the rupturing disc thereby actuating the system 600.

With reference to FIG. 6, the preferred system includes a preferably centralized controller for automated and manual operation and monitoring of the system 600. More specifically, the system 600 includes the centralized controller or interface control module (ICM) 620. Preferably coupled to the ICM 620 is a display device 622 which displays information to a user and a provides for user input to the ICM 620. An audio alarm or speaker 623 may also be coupled to the ICM 620 to provide for an audio alert regarding the status of the system 600. More preferably, an audio alarm or sounder is incorporated into the housing of the display device 622 and configured to operate in a wet environment.

To provide for fire detection and actuation of the cylinder assemblies 616 and the fire protection system, the ICM 620 further includes an input data bus 624 coupled to one or more detection sensors, an output data bus 626 coupled to the preferred PADs 618 and input power supply bus 630 for powering the ICM 620 and the control and actuating signals as explained in greater detail below. The input bus 624 preferably provides for interconnection of digital and analog devices to the ICM 620; and more preferably includes one or more fire detection devices 632 and preferably at least one manual actuating device 634. The fire detection devices 632 of the system 600 can include analog and digital devices for various modes for fire detection including: (i) spot thermal detectors 632a to determine when the surrounding air exceeds a set temperature, (ii) linear detection wire 632b which conveys a detection signal from two wires that are brought into contact upon a separating insulation material melting in the presence of a fire, (iii) optical sensors 632c which differentiate between open flames and hydrocarbon signatures, and (iv) a linear pressure detector 632d in which pressure of an air line increases in the presence of sufficient heat. Examples of the detection devices are shown and described in which is attached to U.S. Provisional Patent Application No. 61/704,551. The manual actuating device 634 is preferably a manual push button which sends an actuating signal to the ICM 620 for output of an electrical actuating signal along to the PAD 618 of the pressurized cylinder assembly 616. Accordingly, the preferred system provides for manual actuation of the system via an electrical signal to the PAD. Together the detection and manual actuating devices 632, 634 define a detecting circuit of the system 600 of either an automatic or manual detection of a fire event.

The devices 632, 634 of the input bus 624 may be interconnected by two or more interconnected connection cables which may include one or more sections of linear detection wire 632b. The cables are preferably connected by connectors 625. The connection cable of the input bus 624 is coupled to the ICM. The connection cables of the input and output buses 624, 626 preferably define closed electrical circuits with the ICM 620. Accordingly, a bus may include one or more branch terminators, for example, at the end of a linear detection wire. Additionally, the detecting circuit can include an end of line element which terminates the physically furthest end of the input bus, for example, and monitors the detecting circuit of the system 600. The detection devices 632, 634 may be digital devices for direct communication with the ICM 620 as seen in FIG. 1. Alternatively, the detection devices may be analog devices which are coupled to one or more detection modules 636 for preferred digital communication with the ICM 620.

Referring again to FIG. 6, the ICM 620 is preferably a programmable controller having a microprocessor or microchip. The ICM preferably receives input signals on the input bus 624 from the detection devices 632 for processing and where appropriate, generating an actuating signal to the PAD along the output bus 626. Moreover, the processor is preferably configured for receiving feedback signals from each of the input and output buses to determine the status of the system and its various components. More specifically, the ICM may include internal circuitry to detect the status of the input bus, i.e., in a normal state, ground state, whether there is an open circuit, or whether there has been a signal for manual release. In some embodiments, ICM 620 is configured to perform any of the functionality of controller 856 and/or control panel 12 as described in greater detail above with reference to FIGS. 1-5.

### Configuration of Exemplary Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

What is claimed is:

1. A fire suppression system for a vehicle, the fire suppression system comprising:
a housing;
a plurality of battery cells positioned within the housing and configured to provide power to a system of the vehicle;
an off-gas detector coupled to the housing and configured to detect a presence of off-gas in the housing; and
a controller configured to:
receive signals from the off-gas detector indicating whether off-gas is detected in the housing; and
activate a fire suppression apparatus to provide fire suppressant agent to any of an exterior or interior of the housing in response to detecting off-gas in the housing.

2. The fire suppression system of claim 1, further comprising one or more temperature sensors configured to be positioned about the vehicle and detect temperatures at a plurality of locations about the vehicle.

3. The fire suppression system of claim 2, wherein the controller is configured to selectively activate the fire suppression apparatus to provide the fire suppressant agent to one or more of the plurality of locations about the vehicle based on the detected temperatures.

4. The fire suppression system of claim 1, wherein the off-gas detector comprises a plurality of off-gas detectors, wherein each of the plurality of off-gas detectors is configured to detect the presence of off-gas emitted by a corresponding plurality of battery cells.

5. The fire suppression system of claim 1, wherein the off-gas detector is configured to detect a presence or concentration of any of a lithium-ion battery off-gas, carbon dioxide, methane, ethane, hydrogen, oxygen, nitrogen oxides, volatile organic compounds, ash, soot, hydrogen sulfide, sulfur oxides, ammonia, chlorine, propane, ozone, ethanol, hydrocarbons, hydrogen cyanide, combustible cases, flammable gases, toxic gases, corrosive gases, oxidizing gases, or an electrolyte vapor in an air sample.

6. The fire suppression system of claim 1, wherein the controller is configured to:
receive signals from the off-gas detector indicating a concentration of off-gas;
compare the concentration of off-gas to a threshold value; and
activate the fire suppression apparatus in response to the concentration of off-gas in an air sample exceeding the threshold value.

7. The fire suppression system of claim 1, wherein the controller is configured to deactivate the plurality of battery cells in response to detecting the off-gas in the housing.

8. The fire suppression system of claim 1, wherein the plurality of battery cells are removable from the housing.

9. The fire suppression system of claim 1, further comprising a first fire suppression apparatus and a second fire suppression apparatus, wherein the first fire suppression apparatus is configured to provide a first type of fire suppressant agent to the housing and the second fire suppression apparatus is configured to provide a second type of fire suppressant agent to the housing.

10. The fire suppression system of claim 9, wherein the controller is configured to activate the first fire suppression apparatus to provide the first type of fire suppressant agent to the plurality of battery cells at a first time, and activate the second fire suppression apparatus to provide the second type of fire suppressant agent to the plurality of battery cells at a second time, wherein the second time occurs after the first time.

11. A vehicle comprising:
a plurality of battery cells positioned within a housing;
an off-gas detector provided within the housing and configured to detect a presence of off-gas in the housing; and
a controller configured to:
receive signals from the off-gas detector indicating whether off-gas is detected in the housing; and
activate a fire suppression apparatus to provide fire suppressant agent to the plurality of battery cells in response to detecting off-gas in the housing.

12. The vehicle of claim 11, further comprising an electric motor configured to draw power from the plurality of battery cells for one or more operations of the vehicle.

13. The vehicle of claim 12, wherein the one or more operations of the vehicle powered by the electric motor and the plurality of battery cells comprise any of:
a driving operation;
lighting operations;
accessory drive operations; or
vehicle-specific operations.

14. The vehicle of claim 11, further comprising one or more temperature sensors positioned about the vehicle and configured to detect temperatures at different locations about the vehicle.

15. The vehicle of claim 14, wherein the controller is configured to selectively activate the fire suppression apparatus to provide the fire suppressant agent to one or more of the different locations about the vehicle based on the detected temperatures.

16. The vehicle of claim 11, wherein the off-gas detector comprises a plurality of off-gas detectors, wherein each of the plurality of off-gas detectors is configured to detect the presence of off-gas emitted by a corresponding plurality of battery cells.

17. A method for detecting a fire condition of a vehicle and responding to the fire condition, the method comprising:
sampling air in a battery rack of the vehicle, the battery rack comprising a plurality of batteries configured to power a vehicle system;
determining a concentration of the off-gas in the air sampled from the battery rack of the vehicle;
comparing the concentration of the off-gas in the air to a threshold concentration; and
activating a fire suppression system of the vehicle in response to the concentration of the off-gas in the air exceeding the threshold concentration.

18. The method of claim 17, further comprising:
obtaining temperature data and smoke detection data from one or more sensors of the battery rack;
analyzing the temperature data and the smoke detection data to determine if at least one of the temperature data or the smoke detection data indicates that a fire condition is present; and
activating the fire suppression system of the vehicle in response to at least one of the temperature data or the smoke detection data indicating that the fire condition is present.

19. The method of claim 18, wherein obtaining the temperature data and the smoke detection data, analyzing the temperature data, and activating the fire suppression system are performed in response to the concentration of the off-gas in the air being less than the threshold concentration.

20. The method of claim 17, further comprising:
in response to the concentration of the off-gas in the air exceeding the threshold concentration:
providing an alert to an operator of the vehicle; and
shutting off electrical power to the battery rack.
